(19) United States
(12) Patent Application Publication
(10) Pub. No.: US 2023/0085087 A1
(43) Pub. Date: Mar. 16, 2023

(54) Voice-Controlled Smart Device and Method of Use Thereof

(71) Applicants: Alexis Herrera, Delano, CA (US); Jennifer Salgado, Delano, CA (US)

(72) Inventors: Alexis Herrera, Delano, CA (US); Jennifer Salgado, Delano, CA (US)

(21) Appl. No.: 17/751,872

(22) Filed: May 24, 2022

Related U.S. Application Data
(60) Provisional application No. 63/243,316, filed on Sep. 13, 2021.

(51) Int. Cl. G10L 17/22; H04R 1/02; H04R 1/08; H04R 3/00; G10L 17/06; G10L 25/51; G10L 25/78; F21V 33/00

(52) U.S. Cl. CPC G10L 17/22; H04R 1/025; H04R 1/08; H04R 3/00; G10L 17/06; G10L 25/51; G10L 25/78; F21V 33/0056; F21Y 2115/10

(57) ABSTRACT

The present invention relates to an infinity-shaped virtual assistant device. The device is configured to receive voice commands via one or more microphones and to emit voice response messages via one or more speakers. The device processes the received voice commands using voice processing modules for performing an appropriate action. The device mimics voice(s), or emits recorded messages, of a selected individual thereby enabling a user to have a conversation or listen to voices of their loved ones. Internal memory of the device stores pre-recorded messages that can be audibly emitted via speakers. A communication interface of the device allows the device to communicate with remote devices, servers, and more. The device is powered by rechargeable batteries and includes LEDs that illuminate while the device is operating.

### CROSS-REFERENCE TO RELATED APPLICATION

The present application claims priority to, and the benefit of, U.S. Provisional Application No. 63/243,316, which was filed on Sep. 13, 2021 and is incorporated herein by reference in its entirety.

### FIELD OF THE INVENTION

The present invention relates generally to voice assistant systems. More specifically, the present invention relates to an infinity-shaped voice-controlled portable device for use at homes, offices, schools, and much more. The device allows individuals to store voices of their loved ones and the voices can be used for playing out or audibly emitting voice response messages. The device receives user voice commands, performs an appropriate action, and plays out or audibly emits a confirmation voice response. The device is configured to be used for controlling smart appliances, playing music, providing information to a user, and much more. Accordingly, the present disclosure makes specific reference thereto. Nonetheless, it is to be appreciated that aspects of the present invention are also equally applicable to other like applications, devices, and methods of manufacture.

### BACKGROUND

Home electronic devices are generally operated manually by users. Manual operation of such electronic devices such as lights, fans, appliances, and more is frustrating, discomforting and time consuming. Individuals desire a device that can easily control and operate all such home electronic devices.

Now a days, home electronic devices can be controlled remotely using software applications running on mobile phones, tablet computers, laptop computers, desktop computers, or the like. While these devices can provide users with a greater level of control and convenience, it can become exceedingly difficult to manage these devices as the number of remotely controlled devices and separate applications controlling these devices in the home increase. Individuals need to remember which application controls which electronic device. Further, individuals find it difficult to always access their personal devices for controlling the devices. Individuals desire a device that can easily operate all home electronic devices without necessarily accessing smartphone applications.

Individuals miss their loved ones after they pass away and want to hear their voice or want to have a virtual conversation with them. Currently, individuals have access to photos and videos of their loved ones but are prohibited from having a virtual conversation with them. Individuals desire a device that can mimic a conversation with their loved ones for a personal and comforting interaction.

Individuals generally access the internet and applications for accessing general information, for example, the weather, the time, et. al. Further, individuals need to continually type or send a voice command by opening different applications to get the requested general information. Individuals desire a device that can easily provide to them general information by giving an easy and convenient voice command.

Therefore, there exists a long-felt need in the art for a device that connects wirelessly to several different home systems. There is also a long-felt need in the art for a device that can control lights, temperature ambience, smartphones, radio music, and more. Additionally, there is a long-felt need in the art for device that can mimic the human voice so that users can have phrases with a loved one's voice audibly emitted (i.e., mimicked) from the device. Further, there is a long-felt need in the art for a device that allows users to easily obtain general information. Furthermore, there is a long-felt need in the art of a device that obviates users from typing their queries and looking at screens of electronic devices to receive information. Finally, there is a long-felt need in the art for a multipurpose device that provides a method for using the device in a plurality of ways at homes, offices, schools, and much more and that receives and plays voice messages for easy access to the users.

The subject matter disclosed and claimed herein, in one embodiment thereof, comprises a voice-controlled smart device. The voice-controlled smart device can comprise an infinity symbol shaped device that is portable, lightweight, voice operated, and comes in a variety of colors and designs. The device has a microphone for receiving a voice command, an automatic speech recognition (ASR) module for detecting human speech from the voice command, a natural language understanding (NLU) module for interpreting intent of the voice command, a voice DNA analysis module for identifying attributes of the voice, wherein said ASR module, NLU module and voice DNA analysis module together process the received voice command, a processor executing an action as per the received voice command, at least two speakers for playing out (i.e., audibly emitting) a voice response message, and a plurality of LEDs illuminating in a variety of colors wherein LEDs illuminate in different colors when the microphone is activated and when the speakers are activated. The device has a communication interface enabling the device to establish a wireless channel to connect to a remote device, a server, and more.

In this manner, the multipurpose virtual assistant device and associated method of the present invention accomplishes all of the foregoing objectives and provides users an effective way of managing and controlling home appliances, listening to a voice of their deceased loved ones, getting general information, listening to music, and obviating mandatory use of display devices. The device ensures individuals can maintain positivity throughout the day by listening to motivational and encouraging messages from their loved ones.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a voice-controlled smart device. The voice-controlled smart device further comprising an infinity symbol shaped body, at least one microphone for receiving a voice command, an automatic speech recognition (ASR) module for detecting human speech from the voice command, a natural language understanding (NLU) module for interpreting intent of the voice command, a voice DNA analysis module for identifying attributes of the voice, wherein said ASR module, NLU module and voice DNA analysis module together process the received voice command, a processor executing an action as per the received voice command, at least two speakers for playing out (i.e., audibly emitting) a voice response message, and a plurality of LEDs illuminating in a variety of colors wherein LEDs illuminate in different colors when the microphone is activated and when the speakers are activated. The device has a communication interface enabling the device to establish a wireless channel to connect to a remote device, a server, and more.

In a further embodiment of the present invention, a voice assistant device is disclosed. The voice assistant device includes an infinity-shaped housing, one or more microphones for capturing voice commands, voice processing modules for processing received voice commands wherein the processing includes selection of a voice for responding to the voice commands, one or more speakers for playing out (i.e., audibly emitting) a voice response in said selected voice, the selection of voice is based on a user identification word detected in the voice command.

In yet another embodiment of the present invention, the voice is associated with the user identification word and is stored in the internal memory of the device.

In yet another embodiment of the present invention, a method for operating a voice-controlled hub device is described. The method includes the steps of receiving, via one or more microphones, a voice input; processing, by a natural language understanding module, the voice input for identifying intent in the voice input; performing, by a processor, an appropriate action based on said processing; and outputting, via one or more speakers, a voice response as a result of performing the appropriate action.

In yet another embodiment, the method further comprising, receiving, via one or more microphones, a voice input from a remote handheld device.

In yet another embodiment, the method further comprising, detecting in the voice input, one or more ‘wake’ words for activating the hub device.

In yet another embodiment, the method further comprising, selecting a voice for providing said voice response.

In yet another embodiment, the appropriate action is turning on or off a smart appliance.

The advantage of the system and method of the present invention is that it allows friends and family to listen to a particular voice in a customized message from a deceased person. The smart device can also be used to control various aspects of a room, such as, air conditioning, lighting, music, and more. The device ensures that individuals can maintain positivity throughout the day by listening to motivational and encouraging messages from their loved ones (i.e., past and present).

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 is a perspective view of a voice enabled smart device of the present invention in accordance with the disclosed architecture;

FIG. 2 illustrates a block diagram showing internal components of the voice enabled smart device of the present invention in accordance with the disclosed architecture;

FIG. 3 illustrates a schematic view of connection of the smart device with a smartphone having an installed computer implemented software application for controlling the smart device in accordance with the disclosed architecture;

FIG. 4 illustrates an exemplary user interface displayed by the software application for controlling the smart device in accordance with the disclosed architecture;

FIG. 5 illustrates a flow diagram depicting a process of communication between the voice enabled smart device and a smart appliance for enabling the device to control the smart appliance in accordance with the disclosed architecture;

FIG. 6 illustrates a flow diagram depicting a process of storing a voice message and associating one or more user identification names with the voice message for future playback by the voice enabled smart device in accordance with the disclosed architecture;

FIGS. 7A and 7B illustrate exemplary views of a user communicating with voice-controlled device of the present invention where the voice response of the device has a specific voice characteristic in accordance with the disclosed architecture;

FIG. 8 illustrates a flow diagram depicting a process of providing a voice response message by the device in a customized voice based on detecting user identification keywords in a voice message received from a user in accordance with the disclosed architecture;

FIG. 9 illustrates a flow diagram depicting a process of detecting one or more specific ‘wake’ words for activating processing of the received voice messages by the smart device of the present invention in accordance with the disclosed architecture;

FIG. 10 illustrates an alternative implementation of the voice processing by the voice-controlled smart device of the present invention in accordance with the disclosed architecture; and

FIG. 11 illustrates an exemplary user device that is used for installing the software application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that connects wirelessly to several different home systems. There is also a long-felt need in the art for a device that can control lights, temperature ambience, smartphones, radio music, and more. Additionally, there is a long-felt need in the art for device that can mimic the human voice so that users can have phrases with a loved one's voice audibly emitted (i.e., mimicked) from the device. Further, there is a long-felt need in the art for a device that allows users to easily obtain general information. Furthermore, there is a long-felt need in the art for a device that obviates users from typing their queries and looking at screens of electronic devices to receive information. Finally, there is a long-felt need in the art for a multipurpose device that provides a method for using the device in a plurality of ways at homes, offices, schools, and much more and that receives and plays voice messages for easy access to the users.

The present invention, in one exemplary embodiment, is a novel method for operating a voice-controlled hub device. The method includes the steps of receiving, via one or more microphones, a voice input; processing, by a natural language understanding module, the voice input for identifying intent in the voice input; performing, by a processor, an appropriate action based on said processing; and outputting, via one or more speakers, a voice response as a result of performing the appropriate action.

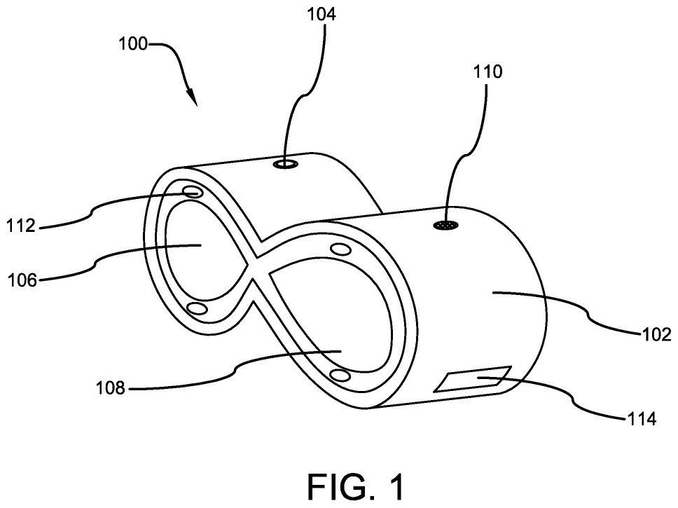

Referring initially to the drawings, FIG. 1 is a perspective view of the voice enabled smart device 100 of the present invention in accordance with the disclosed architecture. The smart device 100 of the present invention has an infinity-symbol shaped body 102 and is designed to be activated in response to detecting voice input or a specific sound or word (referred to as a ‘wake’ word). The smart electronic device 100 is designed to receive a voice command and perform one or more actions in response to the received voice commands.

As illustrated, the device 100 has a power on/off button 104 which can be a physical or touch button for enabling or disabling the device 100. A pair of high-definition surround sound speakers 106, 108 are positioned for playing out (i.e., audibly emitting) voice responses from the device 100. The left speaker 106 and the right speaker 108, together provide surround sound effect of the device 100. A microphone 110 is positioned to detect sound in the environment of the device 100. For instance, the microphone(s) 110 can be mounted on top wall of the body 102 of the playback device 100. The microphone(s) 110 can be any type of microphone now known or later developed such as an electret condenser microphone, a condenser microphone, a dynamic microphone and more. It should be noted that when the speakers 106, 108 are operational, the microphone 110 is not active and similarly, when the microphone 110 is operational, the speakers 106, 108 are disabled.

The device 100 has a plurality of LEDs 112 disposed along the body 102. The LEDs 112 are configured to illuminate in single color or multi color when the device 100 is active. The LEDs 112 can illuminate in different colors when the speakers 106, 108 are active and when the microphone 110 is active.

The device 100 is a one-piece structure that is lightweight, portable, and available in a variety of colors and designs. The device 100 has a battery socket 114 for housing batteries that provide power to the device 100 to effectively work.

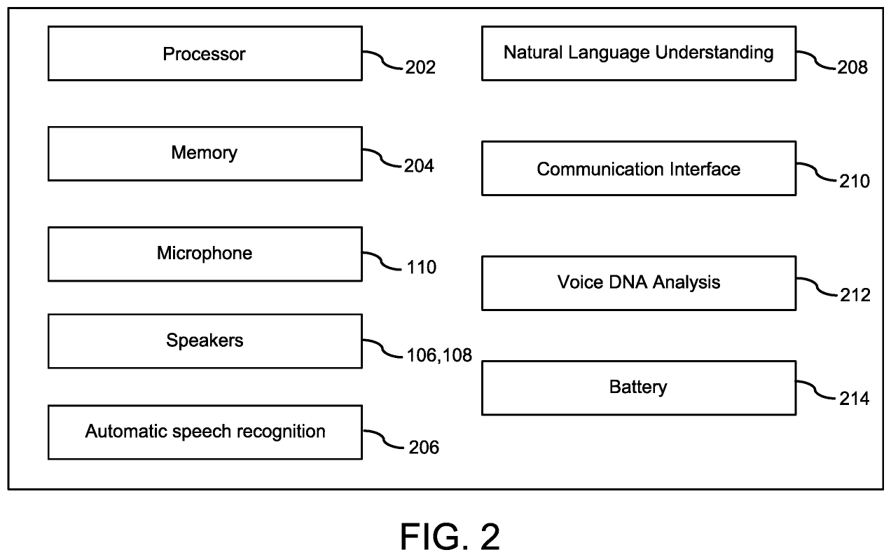

FIG. 2 illustrates a block diagram showing internal components of the voice enabled smart device 100 of the present invention in accordance with the disclosed architecture. The device 100 is an electronic device comprising a processor 202 for controlling operations of the device 100. The processor 202 is configured to facilitate communication between the components of the device 100. As an example, the processor 202 activates LEDs 112 when speakers 106, 108 are enabled and changes color of the LEDs when microphone 110 is activated. The processor 202 can include a central processing unit (“CPU”), a graphic processing unit (“GPU”), one or more microprocessors, a digital signal processor, or any other type of processor, or any combination thereof. The processor 202 can be a combination of field-programmable gate arrays (“FPGA”), application specific integrated circuits (“ASICs”), application-specific standard products (“ASSPs”), system-on-chip systems (“SOCs”), complex programmable logic devices (“CPLDs”) and more.

An internal memory/storage 204 is used for storing recorded voice messages of users of the device. The storage 204 can also be used for storing music as per preference of the users. The memory/storage 204 can be any volatile or non-volatile memory, or any removable or non-removable memory implemented in any suitable manner to store data on the voice activated electronic device 100. Various types of storage/memory can include, but are not limited to, solid state drives, flash memory, permanent memory (e.g., ROM), electronically erasable programmable read-only memory (“EEPROM”), CD-ROM, hard drives, or other optical storage medium, magnetic cassettes, magnetic tapes, magnetic disk storage or other magnetic storage devices, RAID storage systems, or any other storage type, or any combination thereof.

The microphone 110 as described earlier is used for detecting sound in the environment of the device 100. A voice command of a user is captured by the microphone 110 and is processed by the device 110 for performing an appropriate action. Speakers 106, 108 as described earlier are used for playing out (i.e., audibly emitting) voice response messages of the device 100 in response to processing of the voice commands of the user.

An automatic speech recognition module 206 is configured to detect human speech thereby activating the device 100 for processing of the voice command. The module 206 detects utterances/words from the microphone and provides the speech to the Natural Language Understanding (NLU) module 208. The NLU module 208 is used for identifying keywords and the query from the voice command received by the device 100. The NLU module 208 detects if a user is asking a query for a weather report, a motivational message, controlling a smart appliance, or more. The NLU module 208 is designed to interpret intent of the user from the keywords and enabling the device 100 to perform an appropriate action based on the interpreted intent of the user. For example, when the NLU module 208 receives “set” and “temperature” from a voice command “set temperature of air conditioner to 18 degrees Celsius, then, the NLU module 208 interprets the intent of the user of setting the temperature of a smart appliance.

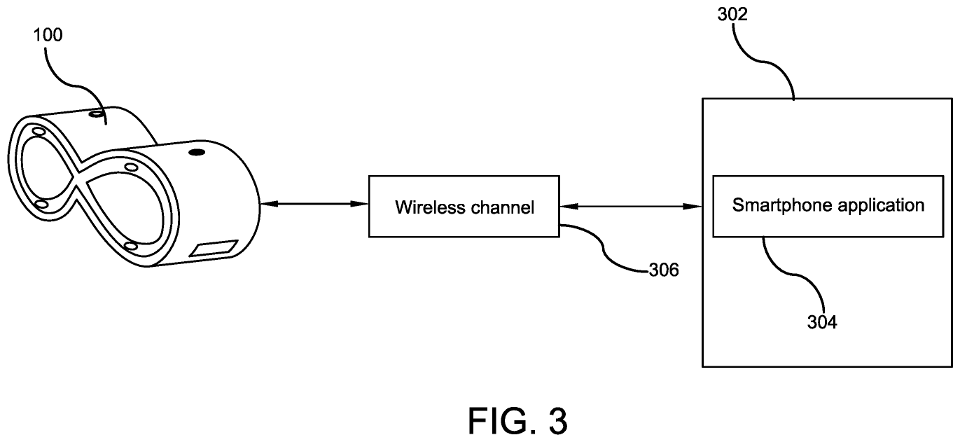

A communication interface 210 embedded in the device 100 enables the voice activated electronic device 100 to communicate with one or more remote electronic devices, one or more servers, and/or systems as shown in FIGS. 3, 4, and 9. The communication interface 210 can use Transfer Control Protocol and Internet Protocol (“TCP/IP”) (e.g., any of the protocols used in each of the TCP/IP layers), Hypertext Transfer Protocol (“HTTP”), and wireless application protocol (“WAP”). The communication interface 210 can also include Wi-Fi (e.g., 802.11 protocol), Bluetooth®, Zigbee, radio frequency systems, cellular networks (e.g., GSM, AMPS, GPRS, CDMA, EDGE, 3GSM, LTE or any other suitable cellular network protocol), infrared, FTP, RTP, RTSP, SSH, and/or VOIP.

A voice DNA analysis module 212 is used for performing deep and forensic analysis of voice of a user. The module 212 identifies tone and texture of a voice and helps in associating a specific voice with a user name wherein the correlated voice and user name or identification are stored in internal memory 204 of the device 100.

The device 100 has rechargeable batteries 214 that are stored in the battery socket 114. The batteries 214 are replaceable and rechargeable and provides power to the electronic components of the device 100.

FIG. 3 illustrates a schematic view of connection of the smart device 100 with a smartphone 302 having an installed computer implemented software application 304 for controlling the smart device 100 in accordance with the disclosed architecture. The communication interface of the device 100 allows the device 100 to establish a wireless channel 306 with a handheld electronic device such as a smartphone 302. The smartphone 302 has an installed computer implemented application 304 that provides interface for controlling and operating the device 100 remotely.

The computer implemented application 304 is configured to control one or more eternity devices 100. In one embodiment, a user can record one or more voice messages in internal memory of the device 100 for future playback. The application 304 also provides the ability to a user to control various smart appliances in the home using the smart device 100 via the smartphone 302.

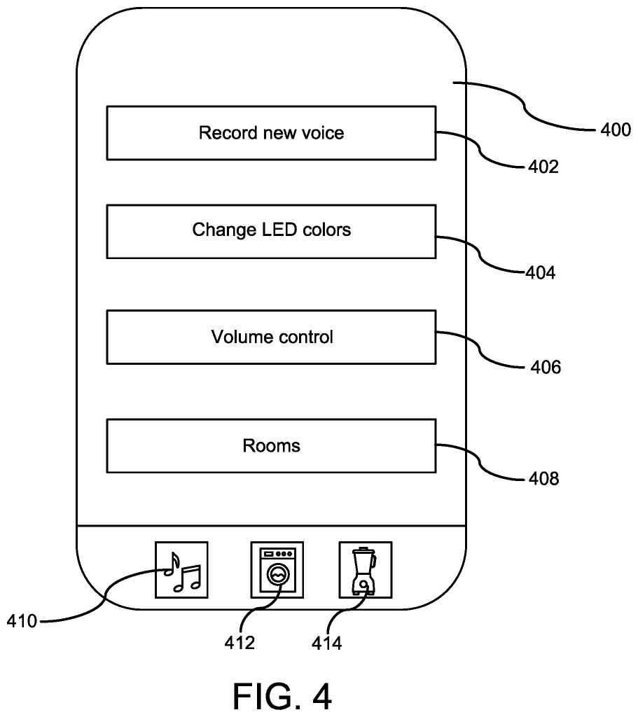

FIG. 4 illustrates an exemplary user interface 400 displayed by the software application 304 for controlling the smart device 100 in accordance with the disclosed architecture. As illustrated, the user interface 400 displays a record new voice icon 402 that allows a user to record a new voice and transmit to the voice enabled device 100 for storage in internal memory. For recording the new voice or voice message, the application 304 uses the microphone of the handheld device 302. A previous recording of a now deceased person can also be stored in the internal memory of the device 100 and its contemplated that artificial intelligence can be used to create messages in the voice of the deceased. A change LED colors icon 404 is used for changing illuminating colors of the LEDs disposed on the device 100. It should be noted that LEDs can also be disabled using the software application 304.

A volume control button 406 allows the user to change tone and volume of voice response messages played out by the smart device 100. Also, the type of the voice can be changed using the application. For example, a user can change the sound of voice response messages from male voice to female voice and vice versa. It should be noted that the device 100 is capable of playing out (i.e., audibly emitting) sounds of pet animals of a user.

To access rooms having smart lights connected with the device 100, a rooms icon 408 is displayed on the user interface 400. The software application 304 allows a user to define or group zones of a home as rooms and the smart appliances connected to the device 100 in a specific zone are collectively operated using the device 100.

The application 304 allows a user to play music by selecting music icon 410. The music icon 410 enables a user to select music from the handheld device 302 and transmits to the smart device 100 for playing out (i.e., audibly emitting). Individual smart appliances 412, 414 set as a favorite by the user are displayed on the bottom of the interface 400 providing quicker access to the user for operating the appliances.

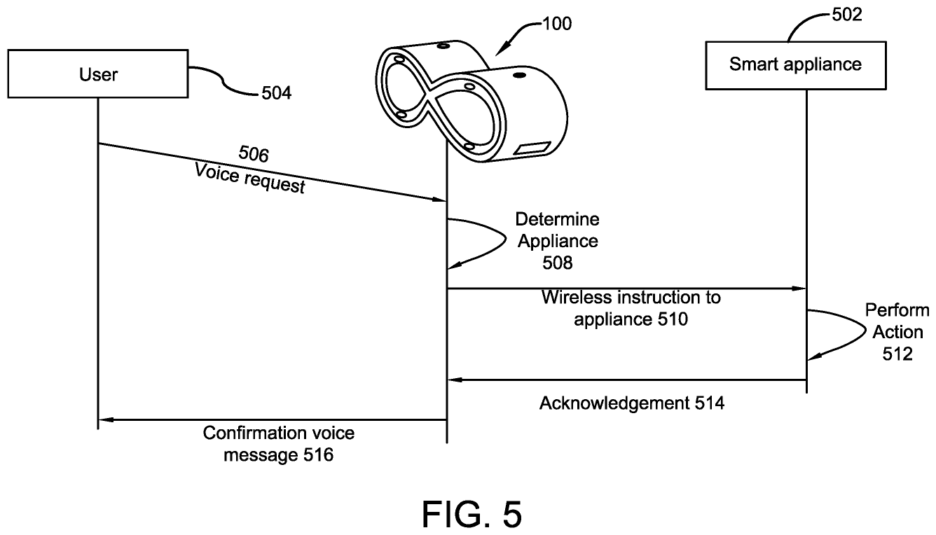

FIG. 5 illustrates a flow diagram depicting a process of communication between the voice enabled smart device 100 and a smart appliance 502 for enabling the device 100 to control the smart appliance 502 in accordance with the disclosed architecture. As illustrated, a voice message from a user is received by microphone of the smart device 100 (Step 504). It should be understood that the voice message is received by the microphone from a user 506 within range of the microphone or alternatively received through a wireless channel from a handheld electronic device as discussed in FIG.4. Then, using the NLU module, a keyword from the voice message indicating the smart appliance (or room or zone) is detected to uniquely identify the smart appliance (Step 508). Thereafter, using the communication interface, a wireless instruction having an encoded request is sent to the smart appliance (Step 510). Then, a required action like turning the appliance ‘on’ or turning the appliance ‘off’ is performed (Step 512) and an acknowledgement is received by the hub 100 from the smart appliance through the wireless channel established between the hub 100 (Step 514) and the appliance 502. Finally, using the speakers of the device 100, a confirmation voice message is played out by the device 100 (Step 516).

The smart appliance 502 can be any network-capable device that can establish communication with hub 100 according to one or more network protocols, such as NFC, Zigbee, WiMAX, Bluetooth, Ethernet, and IEEE 802.11, among other examples, over one or more types of networks, such as wide area networks (WAN), local area networks (LAN), and personal area networks (PAN), among other possibilities.

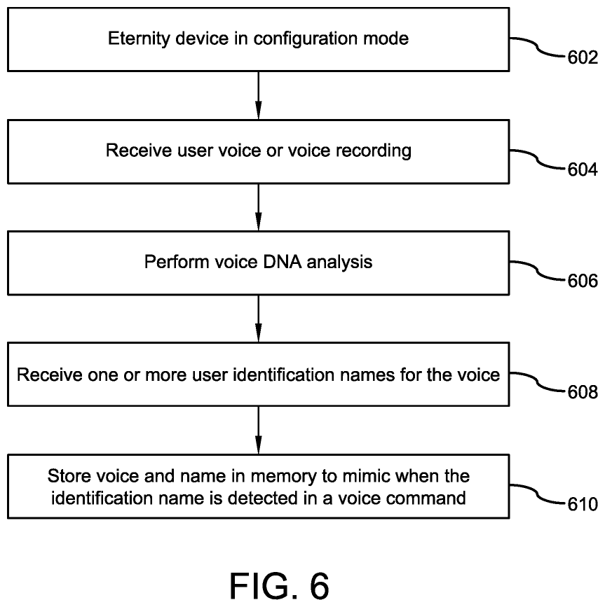

FIG. 6 illustrates a flow diagram depicting a process of storing a voice message and associated one or more user identification names with the voice message for future playback by the voice enabled smart device 100 in accordance with the disclosed architecture. As illustrated, initially, the hub device 100 is put in a configuration mode using a physical button on the device 100 or remotely using the software application (Step 602). Thereafter, the device receives a user voice or voice recording for storage in the internal memory of the device (Step 604). The recording can also be of a now deceased person. The voice DNA analysis module of the device performs DNA analysis of the received voice to identify pitch, frequency, tone, and other attributes of the received voice (Step 606). The attributes are used for playing out (i.e., audibly emitting) a message having the same voice characteristics as the stored voice for providing a personalized intent and character to the voice response message of the device.

After receiving and processing of the voice message, one or more user identification names associated with the received voice are received by the device 100 (Step 608). The voice and the identification names associated with the voice are stored in the internal memory of the device for future use (Step 610).

The identification names can be a proper noun or a common noun, that is identified by the ASR module and then the voice associated with the name(s) is used by the device for playing out (i.e., audibly emitting) the message. For example, user identification name can be “Mary” or “mom” associated with a voice of Mary. When, in the future, the device receives a voice message targeting “Mary” or “mom”, then the voice response of the device is in a voice having attributes of the voice and/or include previous voice recordings associated with “Mary” or “mom”. This is an advantageous feature of the device 100 of the present invention as users can listen to messages in a deceased user's voice.

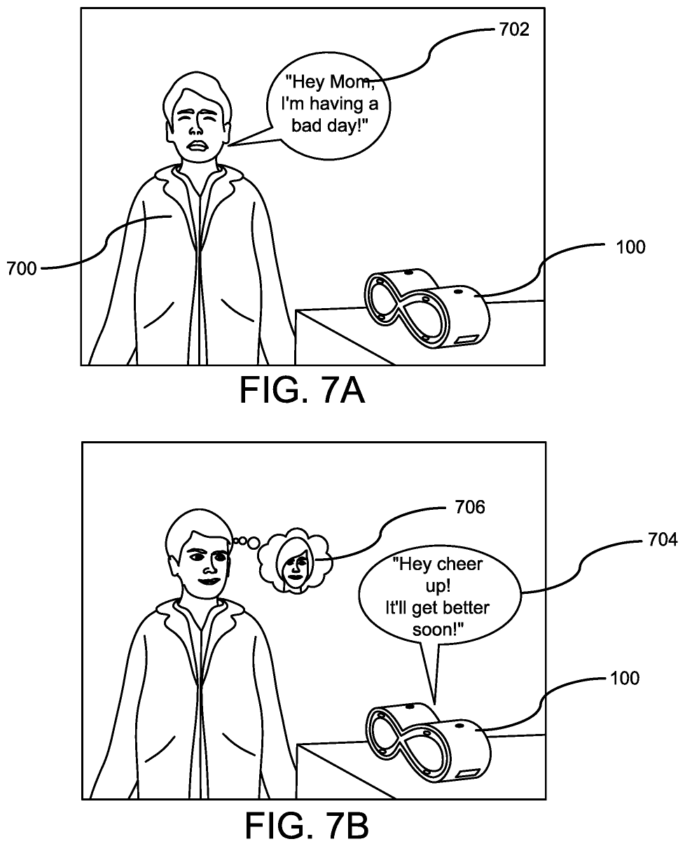

FIGS. 7A and 7B illustrate exemplary views of a user communicating with the voice-controlled device 100 of the present invention where the voice response of the device 100 has a specific voice characteristic in accordance with the disclosed architecture. As illustrated in FIG. 7A, the device 100 receives a message “Hey mom, I'm having a bad day” 702 from a user 700. The microphone of the device 100 captures message and the ASR is activated. Based on DNA analysis and NLU analysis of the voice message 702 by the device 100, an intent and behavior of the user 700 is detected that the user 700 is sad and depressed. Further, a user identification name “mom” stored in the memory of the device 100 is detected by the device 100.

As illustrated in FIG. 7B, the device 100 provides a customized voice response for cheering up the user 700. More specifically, the device 100, plays out the exemplary response message 704 “Hey, cheer up! It'll get better soon son”. The device 100 detects that the user 100 is a male by detecting frequency and pitch of the voice and has addressed the voice message to his mom 706 by detecting a user identification word “mom” in the voice message 702. Accordingly, for motivating and cheering up the user 700, the device 100 plays out the message 704 in a voice having characteristics of a voice associated with ‘mom’ stored in internal memory of the device 100, and/or includes actual previous voice recordings associated with ‘mom’. The device 100 allows a user to listen to messages in a voice of a user who is not physically present or is not alive. Customized phrases in specific voices can also be stored in the device 100 and the messages can be played out by the device 100 as per desire and preferences of the user 700.

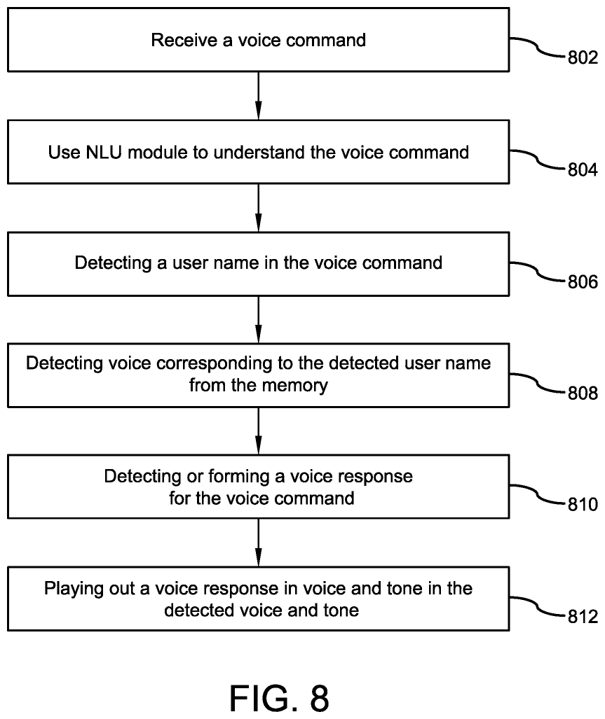

FIG. 8 illustrates a flow diagram depicting a process of providing a voice response message by the device 100 in a customized voice based on detecting user identification keywords in a voice message received from a user in accordance with the disclosed architecture. As illustrated, initially, a voice command is received by the device for performing an appropriate action (Block 802). Then, the device detects the intent of the command using NLU module of the device (Block 804). The voice DNA analysis, along with the NLU module detects, a user identification keyword in the voice command (Block 806).

Thereafter, from the internal memory of the device, voice or voice characteristics corresponding to the detected user name are retrieved for customizing the voice response message (Block 808). Then, a customized voice response is formed by the device in response to the received voice command (Block 810). Finally, the voice response message is played out by the device in a voice having the characteristics of the voice associated with the identified user name(s) (Block 812).

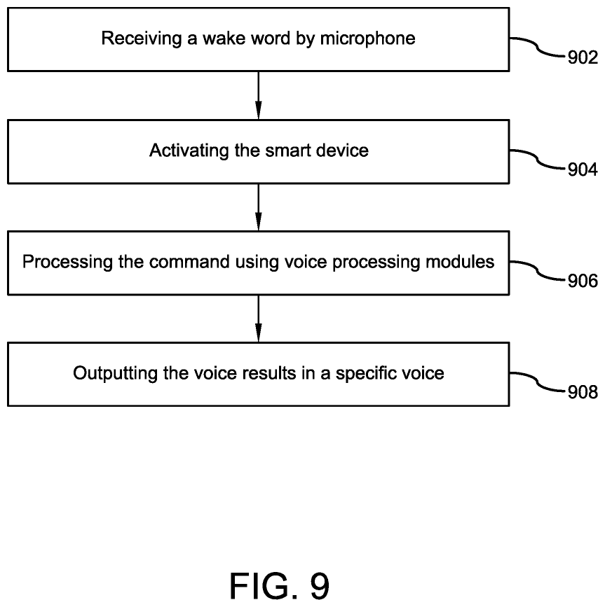

FIG. 9 illustrates a flow diagram depicting a process of detecting one or more specific ‘wake’ words for activating processing of the received voice messages by the smart device 100 of the present invention in accordance with the disclosed architecture. As illustrated, initially, a ‘wake’ word is received in a voice command by the microphone of the device (Step 902). When the ‘wake’ word is received, the device 100 is activated for receiving and processing the voice commands (Step 904). Thereafter, the received voice command is processed using the voice processing modules including NLU module, ASR module, and DNA analysis modules for performing an appropriate action by the device (Step 906).

Finally, a voice response is provided through speakers of the device 100 in response to the received voice command. The voice response can be in a generic voice or in a specific voice as described in FIGS. 6 and 7.

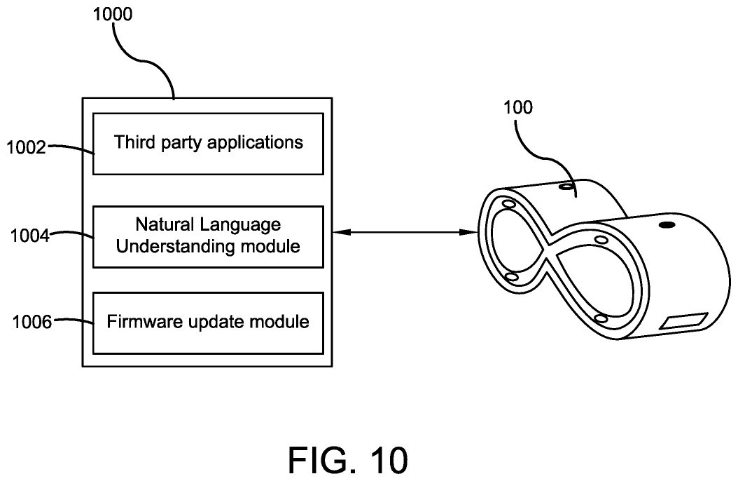

FIG. 10 illustrates an alternative implementation of the voice processing by the voice-controlled smart device 100 of the present invention in accordance with the disclosed architecture. In the present embodiment, the device 100 is connected to a server system 1000 that is used for processing of the voice commands received by the device 100. The received voice command is transmitted from the device 100 to the server 1000 using any conventional communication system. The server system 1000 can have a plurality of third-party applications 1002 (i.e., weather, stocks, sports, and others) for providing information in response to user queries. Processing of the voice commands is performed in the server system 1000 using NLU module 1004 residing in the server 1000. It should be noted that a local processing of the voice command can also be done locally in the device as stated in other embodiments of the present disclosure.

The server system 1000 can have a plurality of other modules necessary for working of the device 100 and can have a firmware update module 1006 for updating firmware of the device 100.

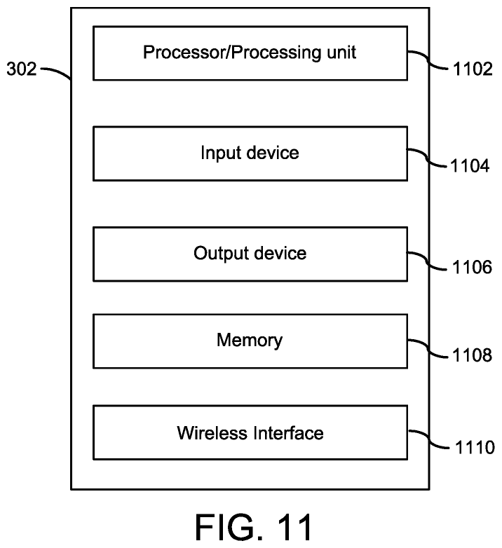

FIG. 11 illustrates an exemplary user device 302 that is used for installing the software application 304 of the present invention in accordance with the disclosed architecture. The processing unit 1102 can include suitable logic, instructions, circuitry, interfaces, and/or codes for executing various operations, such as the operations associated with the user device 302, or the like. The processing unit 1102 can be configured to control one or more operations executed by the user device 302 in response to the input received at the user device 302 from the user. The processor 1102 executes the computer readable instructions stored in the application. Examples of the processing unit 1102 can include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include or otherwise cover any type of the processing unit 1102 including known, related art, and/or later developed processing units. The user device 302 can further include one or more computer executable applications configured to be executed by the processing unit 1102. The one or more computer executable applications can include suitable logic, instructions, and/or codes for executing various operations. The one or more computer executable applications can be stored in the memory 1108. The one or more computer executable applications includes the application 304.

The user device 302 includes input devices 1104 such as a touch input device, voice input device, etc. for entering data and information. Preferably, the touch interface of the user device 302 is used as the input and various buttons/tabs shown on the application are pressed or clicked by the user. Other input devices such as cameras and microphones are used during video chatting by the user. The display of the user device 302 also acts as the output device 1106 for displaying various contents (e.g., text, images, videos, icons, and/or symbols, etc.) to the user. The display can include a touch screen, and can receive, for example, a touch, gesture, proximity, or hovering input using an electronic pen or a part of a user's body.

Electronic device 302 has memory 1108 used for storing programs (sequences of instructions) or data (e.g., program state information) on a temporary or permanent basis for use in the computer system. Memory 1108 can be configured for short-term storage of information as volatile memory and therefore not retained as stored contents if powered off. Examples of volatile memories include random access memories (RAM), dynamic random-access memories (DRAM), static random-access memories (SRAM), and other forms of volatile memories known in the art. The processor 1102, in combination with one or more of memory 1108, input device(s) 1104, output device(s) 1106 is utilized to enable users to execute instructions on the application 304. The connection to a network is provided by wireless interface 1110.

The wireless interface 1110 enables the user device 302 to communicate with the server and other components over a communication network, according to embodiments of the present disclosure. Examples of the communication interface 1110 can include, but are not limited to, a modem, a network interface such as an ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit.

Embodiments of the present disclosure take the form of computer-executable instructions, including algorithms, executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart device”, “smart hub device”, “virtual assistant device”, “voice-controlled smart device”, and “voice enabled smart device” are interchangeable and refer to the voice-controlled smart device 100 of the present invention.

Notwithstanding the foregoing, the voice-controlled smart device 100 of the present invention can be of any suitable size and configuration as is known in the art without affecting the overall concept of the invention, provided that it accomplishes the above-stated objectives. One of ordinary skill in the art will appreciate that the voice-controlled smart device 100 as shown in the FIGS. are for illustrative purposes only, and that many other sizes and shapes of the voice-controlled smart device 100 are well within the scope of the present disclosure. Although the dimensions of the voice-controlled smart device 100 are important design parameters for user convenience, the voice-controlled smart device 100 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A virtual assistant device comprising:
a power on and off button, wherein said power button is a touch button for enabling or disabling said virtual assistant device;
at least speaker positioned to audibly emit a voice message from said virtual assistant device;
a microphone positioned to detect sound in an environment of said virtual assistant device, wherein said microphone is selected from a group consisting of an electret condenser microphone, a condenser microphone, and a dynamic microphone;
an internal memory storage for storing the voice message of a selected individual by a user of said virtual assistant device;
wherein said detected sound is a voice command of a user and said virtual assistant device is voice enabled;
wherein said voice command is processed by a central processing unit (CPU) for performing an action;
wherein said processing includes an automatic speech recognition module to detect a human speech from said microphone;
wherein said automatic speech recognition module includes a natural language understanding (NLU) module for identifying said voice command;
wherein said at least one speaker audibly emits said voice message in response to processed said voice commands of the user; and
further wherein said voice message is a previously recorded voice message.

2. The virtual assistant device of claim 1 further comprising a plurality of LEDs disposed along an exterior of said virtual assistant device, wherein said plurality of LEDs illuminate when said virtual assistant device is active.

3. The virtual assistant device of claim 1, wherein when said at least one speaker is operational said microphone is disabled, and further wherein when said microphone is operational said at least one speaker is disabled.

4. The virtual assistant device of claim 1, wherein said internal memory storage is selected from a group consisting of a solid state drive, a flash memory, a permanent memory (ROM), an electronically erasable programmable read-only memory (“EEPROM”), a CD-ROM, and a hard drive.

5. The virtual assistant device of claim 4, wherein said internal memory storage is selected from a group consisting of a magnetic cassette, a magnetic tape, a magnetic disk storage, and a RAID storage system.

6. The virtual assistant device of claim 2, wherein said device includes a processor for illuminating said LEDs in a first color when said speakers are enabled, and further wherein said processor illuminating said LEDs in a second color when said microphone is enabled.

7. The virtual assistant device of claim 1, wherein said device includes a rechargeable battery.

8. The virtual assistant device of claim 1, wherein said CPU is selected from a group consisting of a digital signal processor, a field-programmable gate array (“FPGA”), an application specific integrated circuit (“ASIC”), an application-specific standard product (“ASSP”), a system-on-chip system (“SOC”), and a complex programmable logic device (“CPLD”).

9. The virtual assistant of claim 1 further comprising a voice DNA analysis module for performing forensic analysis of said voice commands of the user for identification of the user.

10. The virtual assistant of claim 9, wherein said voice DNA analysis module identifies tone and texture of said voice commands for said identification of the user.

11. A virtual assistant device comprising:
a power on and off button wherein said power button is a touch button for enabling or disabling said virtual assistant device;
at least one speaker is positioned to audibly emit voice messages from said virtual assistant device;
a microphone positioned to detect sound in an environment of said virtual assistant device;
an internal memory storage for storing a voice message of a selected individual by a user of said virtual assistant device;
wherein said selected individual is a relative of the user;
wherein said microphone detects sound in the environment of said virtual assistant device;
wherein said detected sound is a voice command of a user and said virtual assistant device is voice enabled;
wherein said voice command is processed by a central processing unit for performing an action;
wherein said processing includes an automatic speech recognition module to detect human speech from said microphone;
wherein said at least one speaker audibly emits said voice message of said selected individual in response to processed said voice commands of the user; and
further wherein said voice message is a previously recorded voice message.

12. The virtual assistant device of claim 11, wherein said previously recorded voice message is a past recorded voice message of a deceased said selected individual.

13. A virtual assistant device comprising:
a power on and off button wherein said power button is a touch button for enabling or disabling said virtual assistant device;
at least one speaker positioned to audibly emit voice messages from said virtual assistant device;
a microphone positioned to detect sound in an environment of said virtual assistant device;
an internal memory storage for storing a voice message of a selected individual by a user of said virtual assistant device;
wherein said selected individual is a relative of the user;
wherein said microphone detects sound in the environment of said virtual assistant device;
wherein said detected sound is a voice command of a user and said virtual assistant device is voice enabled;
wherein said voice command is processed by a central processing unit for performing an action;
wherein said processing includes an automatic speech recognition module to detect human speech from said microphone;
wherein said at least one speaker audibly emits said voice message of said selected individual in response to processed said voice commands of the user;
wherein said voice message is a previously recorded voice message;
a communication interface for wirelessly connecting said virtual assistant device with another remote device; and
further wherein said another remote device records said voice message and transmits said voice message to said virtual assistant device.

14. The virtual assistant device of claim 13, wherein said previously recorded voice message is a past recorded voice message of a deceased said selected individual.

15. The virtual assistant device of claim 14 further comprising a plurality of LEDs disposed along an exterior of said device, wherein said plurality of LEDs illuminate when said virtual assistant device is active.

16. The virtual assistant device of claim 15, wherein when said at least one speaker is operational said microphone is disabled, and further wherein when said microphone is operational, said at least one speaker is disabled.

17. The virtual assistant device of claim 16, wherein said internal memory storage is selected from a group consisting of a solid state drive, a flash memory, a permanent memory (ROM), an electronically erasable programmable read-only memory (“EEPROM”), a CD-ROM, and a hard drive.

18. The virtual assistant device of claim 17 further comprising a processor for illuminating said plurality of LEDs in a first color when said speakers are enabled, and further wherein said processor illuminating said plurality of LEDs in a second color when said microphone is enabled.

19. The virtual assistant device of claim 18 further comprising a voice DNA analysis module for performing forensic analysis of said voice commands of the user for identification of the user.

20. The virtual assistant of claim 19, wherein said voice DNA analysis module identifies tone and texture of said voice commands for said identification of the user.
